(19) United States
(12) Patent Application Publication
(10) Pub. No.: US 2006/0079649 A1
(43) Pub. Date: Apr. 13, 2006

(54) Method for preparing rubber latex

(76) Inventors: Yu-sung Jung, Yeosu-si (KR); Dong-jin Park, Yeosu-si (KR); Keun-hoon Yoo, Yeosu-si (KR); Chan-hong Lee, Yuseong-gu (KR)

Correspondence Address: CANTOR COLBURN, LLP, 55 GRIFFIN ROAD SOUTH, BLOOMFIELD, CT, 06002, US

(21) Appl. No.: 11/157,614

(22) Filed: Jun. 21, 2005

(30) Foreign Application Priority Data
Oct. 8, 2004 (KR) 10-2004-0080495

(51) Int. Cl. C08F 265/02

(52) U.S. Cl. 525/301

(57) ABSTRACT

The present invention relates to a method for preparing rubber latex. The method of the present invention is characterized in that hard polymer seed is fed into a polymerization reactor equipped with a condenser before the commencement of polymerization and that the condenser is operated from the start of the polymerization, so that the condensate containing the conjugated diene compound is fed into the polymerization reactor with the commencement of the polymerization. In accordance with the method for preparing rubber latex of the present invention, it is possible to prepare core-shell type rubber latex capable of maximizing surface grafting ratio of rubber latex without sacrificing uniformity of polymerization system and particle stabilization and prepare resin having superior impact resistance, coloring property and appearance property(luster), when applied to ABS resins.

### BACKGROUND OF THE INVENTION

1) Field of the Invention

The present invention relates to a method for preparing rubber latex. Particularly, the present invention relates to a method for preparing rubber latex by emulsion polymerization using a polymerization reactor equipped with a condenser. More particularly, the present invention relates to a method for preparing a rubber polymer capable of imparting superior impact resistance, coloring property and gloss to an ABS (acrylonitrile-butadiene-styrene) resin using hard polymer seed from the start of polymerization when monomers condensed by a condenser is fed to the polymerization reactor.

2) Description of the Related Art

In accordance with U.S. Pat. No. 4,024,329, polymerization is commenced at a temperature 5 to 10° C. below the predetermined polymerization temperature and the temperature in the polymerization reactor is gradually increased to the predetermined polymerization temperature by the reaction heat. In case of overheating due to the reaction heat, the condenser is operated to remove the heat. However, this method is undesirable because the temperature at which the polymerization is commenced greatly affects the polymerization rate, thereby causing irregularities in average particle diameter and quality.

In accordance with JP 2003-206304, the monomer condensate is recycled into the polymerization system when the polymerization conversion reaches 0.01 to 3.4 wt %, considering that intermittent monomer dispersion occurs inside the polymerization reactor when the monomer condensate condensed by the condenser is recycled to the polymerization reactor, thereby destabilizing the polymerization system and interrupting particle stabilization. The condensed monomer is collected at a storage tank.

The method of using hard polymer seed can reduce reaction time and offer superior coloring property and gloss in manufacturing an ABS resin. However, the problem of incomplete shell formation on the seed may arise when the monomer is fed at once. That is, the resultant rubber latex may have a much smaller particle diameter than the object particle diameter.

In general, physical properties of an ABS resin are affected by the particle size and structure of rubber latex dispersed in the manufacturing process. Accordingly, it is important prepare rubber latex having a diameter capable of absorbing impact and a structure advantageous in grafting the rubber latex with styrene-acrylonitrile copolymer(SAN) in order to manufacture an ABS resin having superior impact resistance, coloring property and gloss(appearance property).

It is an object of the present invention to solve these problems and to provide a method for preparing core-shell type rubber latex capable of maximizing grafting ratio of the rubber polymer of a graft copolymer without negatively affecting stabilization of polymerization system and particles, in order to prepare rubber latex having superior impact resistance, coloring property and gloss when applied to manufacture of an ABS resin.

### SUMMARY OF THE INVENTION

In order to attain the object, the present invention provides a method for preparing rubber latex characterized in that hard polymer seed is fed into a polymerization reactor equipped with a condenser before commencing polymerization and the condenser is operated from the commencing of polymerization, so that the condensate containing conjugated diene compounds can be fed into the polymerization reactor as the polymerization commences.

### DETAILED DESCRIPTION OF THE INVENTION

Hereunder is given a detailed description of the present invention.

In accordance with the present invention, the hard polymer seed is prepared by seed polymerization.

In the seed polymerization, one or more ethylenic unsaturated monomers can be used as monomer.

In the seed polymerization, a graft crosslinking agent or a crosslinking agent may be used in 0.1 to 10 parts by weight per 100 parts by weight of the monomer.

The ethylenic unsaturated monomer may be an aromatic vinyl compound such as styrene and α-methylstyrene or a vinyl cyanide compound such as acrylate, methacrylate and acrylonitrile.

For the graft crosslinking agent, allyl methacrylate or triallyl isocyanurate, etc. may be used. For the crosslinking agent, ethylene glycol dimethacrylate, propylene glycol dimethacrylate, 1,3-butylene glycol dimethacrylate, 1,4-butylene glycol dimethacrylate, divinylbenzene, etc. may be used.

In accordance with the present invention, the average particle diameter of the seed fed into the polymerization reactor is preferably between 500 Å and 2,000 Å, considering the average particle diameter of the rubber latex. If the average particle diameter of the seed exceeds 2,000 Å, the amount of the seed required to attain the adequate average particle diameter of the final rubber polymer, that is 2,600 to 5,000 Å, increases, so that impact resistance of the resultant ABS resin is reduced. Otherwise, if it is below 500 Å, it is difficult to attain the adequate average particle diameter of the final rubber polymer, or 2,600 to 5,000 Å. Kind and amount of emulsifier used in the seed polymerization process are determined by considering the adequate average particle diameter of the final rubber polymer.

For the emulsifier, alkyl aryl sulfonate, alkali methyl alkyl sulfate, sulfonated alkyl ester, fatty acid soap, alkali salt of rosin acid, alkali salt of oleic acid, etc. can be used alone or in combination. The emulsifier can be used in 0.1 to 3 parts by weight per 100 parts by weight of the monomer.

An electrolyte may be used to secure stability during the seed polymerization process. For the electrolyte, KCl, NaCl, KHCO₃, NaHCO₃, K₂CO₃, Na₂CO₃, KHSO₃, NaHSO₃, K₄P₂O₇, Na₄P₂O₇, K₃PO₄, Na₃PO₄, K₂HPO₄, Na₂HPO₄, etc. may be used alone or in combination. The electrolyte can be used in 0 to 1 part by weight per 100 parts by weight of the monomer.

In the seed polymerization process, water-soluble persulfate or an oil-soluble polymerization initiator may be used as polymerization initiator. Also, an oxidation-reduction polymerization initiator may be used. Preferable water-soluble persulfates are sodium persulfate and potassium persulfate. Preferable oil-soluble polymerization initiators are cumene hydroperoxide, diisopropylbenzene hydroperoxide, azobisisobutyronitrile, t-butyl hydroperoxide, p-methane hydroperoxide, benzoyl peroxide, etc. The oil-soluble polymerization initiator may be used alone or in combination and can be used along with the water-soluble persulfate. The polymerization initiator may be used in 0.1 to 3 parts by weight per 100 parts by weight of the monomer.

In accordance with the present invention, the seed prepared in the seed polymerization process may be used in 10 to 20 parts by weight per 100 parts by weight of the monomer used in the shell rubber polymerization process to be described later.

For the monomer used in the shell rubber polymerization process, an aliphatic conjugated diene compound may be used alone or in combination with an aromatic vinyl compound, such as styrene and α-methylstyrene or a vinyl cyanide compound such as acrylate, methacrylate and acrylonitrile, which are copolymerizable with the aliphatic conjugated diene compound. When used in combination, the aromatic vinyl compound and the vinyl cyanide compound are preferably used in 20 parts by weight per 100 parts by weight of the total monomer.

For the aliphatic conjugated diene compound, 1,3-butadiene, isoprene, chloroprene, pyperylene, etc. and comonomers thereof may be used. To form a perfect shell layer on the latex prepared by the first seed polymerization process, the kind and amount of the emulsifier to be used in the second shell rubber polymerization process need to be determined carefully. The emulsifier should be used in the range in which stability of the latex is not impaired.

For the emulsifier used in the shell rubber polymerization process, alkyl aryl sulfonate, alkali methyl alkyl sulfate, sulfonateed alkyl ester, fatty acid soap, alkali salt of rosin acid, alkali salt of oleic acid, etc. may be used alone or in combination. The emulsifier may be used in 1 to 5 parts by weight per 100 parts by weight of the monomer used in the shell rubber polymerization process.

For the polymerization initiator of the shell rubber polymerization process, water-soluble persulfate, an oil-soluble polymerization initiator or an oxidation-reduction polymerization initiator may be used. Preferably, the water-soluble persulfate may be sodium persulfate, potassium persulfate, etc. and the oil-soluble polymerization initiator may be cumene hydroperoxide, diisopropylbenzene hydroperoxide, azobisisobutyronitrile, t-butyl hydroperoxide, p-methane hydroperoxide, benzoyl peroxide, etc. The oil-soluble polymerization initiator may be used alone or in combination or along with a water-soluble persulfate. The polymerization initiator may be used in 0.1 to 3 parts by weight per 100 parts by weight of the monomer used in the shell rubber polymerization process.

For the electrolyte used in the shell rubber polymerization, KCl, NaCl, KHCO₃, NaHCO₃, K₂CO₃, Na₂CO₃, KHSO₃, NaHSO₃, K₄P₂O₇, Na₄P₂O₇, K₃PO₄, Na₃PO₄, K₂HPO₄, Na₂HPO₄, etc. may be used alone or in combination. The electrolyte may be used in 0.1 to 3 parts by weight per 100 parts by weight of the monomer used in the shell rubber polymerization process.

In the shell rubber polymerization, mercaptan may be used as molecular weight controller. It may be used in 0.1 to 1 part by weight per 100 parts by weight of the total monomer.

Preferably, the final rubber latex obtained by the shell rubber polymerization process has an average particle diameter of 2,600 Å to 5,000 Å. If the average particle diameter exceeds 5,000 Å, excessive coagulum may occur during the polymerization. Otherwise, if it is below 2,600 Å, impact resistance at low temperature may be reduced.

The condenser is operated from the start of polymerization. The polymerization is commenced by feeding the monomer condensed by the condenser at the top of the reactor.

Because hard polymer seed is fed before commencing polymerization, the monomer which is condensed by the condenser and circulated as intermittently dispersed is continuously swelled on the stable particulate seed. As a result, a perfect shell layer can be formed and the rubber latex particle may be stabilized. Consequently, a core-shell type rubber polymer capable of maximizing grafting ratio of the rubber polymer of graft copolymer can be prepared.

Hereinafter, the present invention is described in further detail through examples. However, the following examples are only for the understanding of the present invention and the present invention is not limited to or by them.

### EXAMPLE 1

(Preparation of Seed)

Into a polymerization reactor flushed by nitrogen were collectively added 150 parts by weight of ion-exchanged water, 100 parts by weight of styrene, as a monomer, 2.0 parts by weight of potassium oleate, as an emulsifier, 3 parts by weight of allyl methacrylate, as a graft crosslinking agent, and 0.3 part by weight of potassium persulfate, as an initiator. Reaction was performed at 70° C. for 4 hours to prepare a seed.

The resultant seed had a particle diameter of 1,300 Å.

(Preparation of Shell)

Into a polymerization reactor flushed by nitrogen were collectively added 10 parts by weight of the above-obtained seed, 70 parts by weight of ion-exchanged water, 90 parts by weight of 1,3-butadiene, as a monomer, 1.2 part by weight of potassium rosinate and 1.0 part by weight of potassium oleate, as an emulsifier, 0.7 part by weight of sodium carbonate and 0.8 part by weight of potassium bicarbonate, as an electrolyte, 0.3 part by weight of t-dodecylmercaptan(TDDM), as a molecular weight controller, and 0.3 part by weight of potassium persulfate, as an initiator. With the commencement of polymerization at 70° C., the condenser was operated, so that the 1,3-butadiene condensate condensed by the condenser was recycled into the polymerization reactor. Reaction was performed at 75° C. for 26 hours.

The resultant rubber latex was analyzed. The result is shown in Table 1.

### EXAMPLE 2

Into a polymerization reactor flushed by nitrogen were collectively added 10 parts by weight of the above-obtained seed, 75 parts by weight of ion-exchanged water, 72 parts by weight of 1,3-butadiene, as a monomer, 1.2 part by weight of potassium rosinate and 1.0 part by weight of potassium oleate, as an emulsifier, 0.7 part by weight of sodium carbonate and 0.8 part by weight of potassium bicarbonate, as an electrolyte, 0.3 part by weight of t-dodecylmercaptan(TDDM), as a molecular weight controller, and 0.3 part by weight of potassium persulfate, as an initiator. With the commencement of polymerization at 70° C., the condenser was operated, so that the 1,3-butadiene condensate condensed by the condenser was recycled into the polymerization reactor. Reaction was performed at 70° C. for 13 hours, and then 18 parts by weight of the remaining monomer, or 1,3-butadiene, and 0.03 part by weight of t-dodecylmercaptan were collectively added. Reaction was further performed at 75° C. for 24 hours.

The resultant rubber latex was analyzed. The result is shown in Table 1.

### COMPARATIVE EXAMPLE 1

Into a polymerization reactor flushed by nitrogen were collectively added 75 parts by weight of ion-exchanged water, 100 parts by weight of 1,3-butadiene,as a monomer, 1.2 part by weight of potassium rosinate and 1.5 part by weight of potassium oleate, as an emulsifier, 0.7 part by weight of sodium carbonate(Na₂CO₃) and 0.8 part by weight of potassium bicarbonate(KHCO₃), as an electrolyte, 0.3 part by weight of t-dodecylmercaptan(TDDM), as a molecular weight controller, and 0.3 part by weight of potassium persulfate, as an initiator. With the commencement of polymerization at 70° C., the condenser was operated, so that the 1,3-butadiene condensate condensed by the condenser was recycled into the polymerization reactor. Reaction was performed at 75° C. for 30 hours.

The resultant rubber latex was analyzed. The result is shown in Table 1.

### COMPARATIVE EXAMPLE 2

The procedure of Example 1 was followed, except no condenser was used.

Into a polymerization reactor flushed by nitrogen were collectively added 10 parts by weight of the above-obtained seed, 70 parts by weight of ion-exchanged water, 90 parts by weight of 1,3-butadiene, as a monomer, 1.2 part by weight of potassium rosinate and 1.0 part by weight of potassium oleate, as an emulsifier, 0.7 part by weight of sodium carbonate and 0.8 part by weight of potassium bicarbonate, as an electrolyte, 0.3 part by weight of t-dodecylmercaptan(TDDM), as a molecular weight controller, and 0.3 part by weight of potassium persulfate, as an initiator. Polymerization was commenced at 70° C. Reaction was performed at 75° C. for 28 hours.

The resultant rubber latex was analyzed. The result is shown in Table 1.

### COMPARATIVE EXAMPLE 3

The procedure of Example 2 was followed, except that the reactants were added as dispersed instead of using a condenser.

Into a polymerization reactor flushed by nitrogen were collectively added 10 parts by weight of the above-obtained seed, 75 parts by weight of ion-exchanged water, 72 parts by weight of 1,3-butadiene, as a monomer, 1.2 part by weight of potassium rosinate and 1.0 part by weight of potassium oleate, as an emulsifier, 0.7 part by weight of sodium carbonate and 0.8 part by weight of potassium bicarbonate, as an electrolyte, 0.3 part by weight of t-dodecylmercaptan(TDDM), as a molecular weight controller, and 0.3 part by weight of potassium persulfate, as an initiator. Reaction was performed at 70° C. for 13 hours, and then 18 parts by weight of the remaining monomer, or 1,3-butadiene, and 0.03 part by weight of t-dodecylmercaptan were collectively added. Reaction was further performed at 75° C. for 27 hours.

The resultant rubber latex was analyzed. The result is shown in Table 1.

The analysis method of the rubber latex was as follows.

(a) Gel Content

The latex was solidified with acid or metal salt. It was washed and dried in a vacuum oven of 60° C. for 24 hours. The resultant solid was sliced with scissors. 1 g of the sliced rubber sample was put in 100 g of toluene. It was separated into sol and gel phases by keeping in a dark room at room temperature for 48 hours. The gel content was determined by the following equation.
Gel content (%)=[Weight of insoluble content (gel)/Sample weight]×100 ]Equation 1]
(b) Particle Diameter and Particle Diameter Distribution

Measured with Nicomp 370 HPL by the dynamic laser light scattering method.

(c) Proportion of Coagulum

Proportion of coagulum was determined by the following equation.
Proportion of coagulum=(Weight of coagulum formed inside the reactor/Weight of total monomer)×100 [Equation 2]

TABLE 1

| | | Example 1 | Example 2 | Comp. Example 1 | Comp. Example 2 | Comp. Example 3 |
|---|---|---|---|---|---|---|
| Condenser | | Used | Used | Used | Not used | Not used |
| Ion-exchanged water | | 70 | 75 | 75 | 70 | 75 |
| Seed polymer | | 10 | 10 | Not used | 10 | 10 |
| 1,3-Butadiene | | 90 | 72 | 100 | 90 | 72 |
| Potassium oleate | | 1.2 | 1.2 | 1.2 | 1.2 | 1.2 |
| Potassium rosinate | | 1.0 | 1.0 | 1.5 | 1.0 | 1.0 |
| Sodium carbonate | | 0.7 | 0.7 | 0.7 | 0.8 | 0.7 |
| Potassium bicarbonate | | 0.8 | 0.8 | 0.8 | 0.7 | 0.8 |
| t-Dodecylmercaptan | | 0.3 | 0.3 | 0.3 | 0.3 | 0.3 |
| Potassium persulfate | | 0.3 | 0.3 | 0.3 | 0.3 | 0.3 |
| Collective | Addition time | — | After 13 hours | — | — | After 13 hours |
| addition | 1,3-Butadiene | 0 | 18 | 0 | 0 | 18 |
| | t-Dodecylmercaptan | 0 | 0.03 | 0 | 0 | 0.03 |

| | | | | | |
|---|---|---|---|---|---|
| Polymerization conversion (%) | 90 | 91 | 88 | 90 | 91 |
| Gel content (%) | 70 | 69 | 85 | 79 | 73 |
| Particle diameter(Å) | 3100 | 3000 | 3300 | 2700 | 3100 |
| Portion of coagulum (%) | 0.09 | 0.08 | 0.6 | 0.5 | 0.2 |

### TESTING EXAMPLE 1

Into a polymerization reactor flushed by nitrogen were collectively added 50 parts by weight of the rubber latex prepared in Example 1, 65 parts by weight of ion-exchanged water, 0.1 part by weight of sodium ethylene diamine tetraacetate, 0.005 part by weight of ferrous sulfate, 0.23 part by weight of formaldehyde sodium sulfoxylate and 0.35 part by weight of potassium rosinate. The reactor was heated to 70° C. Then, an emulsion mixture solution comprising 50 parts by weight of ion-exchanged water, 0.65 part by weight of potassium rosinate, 35 parts by weight of styrene, 15 parts by weight of acrylonitrile, 0.4 part by weight of t-dodecylmercaptan and 0.4 part by weight of diisopropylene benzene hydroperoxide was continuously added for 3 hours. The polymerization temperature was increased to 80° C. and reaction was performed for 1 hour.

Polymerization conversion of the obtained polymer was 98%, grafting ratio was 40 % and Portion of coagulum was about 0.25%.

The resultant latex was solidified with sulfuric acid solution and washed to obtain powder. 30 parts by weight of the obtained powder and 70 parts by weight of a styrene-acrylonitrile copolymer (SAN; LG Chem, Product name: 92 HR) were put in a mixer and pelletized using an extruder. A sample for physical property test was obtained using an injection molder.

(a) Izod impact strength—Measured according to ASTM 256 using a sample having a thickness of ¼″.

(b) Surface gloss—Measured according to ASTM D528 at an angle of 45°.

(c) Coloring property—Measured with a SUGA color computer with the green color, to which human eyes are sensitive, as reference and evaluated as L and a values. The lower L and higher a value corresponds to easy red coloring. Coloring test was performed varying the amount of the coloring agent.

### TESTING EXAMPLES 2 to 5

Test was performed as in Testing Example 1, except that the rubber latexes prepared in Example 2 and Comparative Examples 1 to 3 were used.

TABLE 2

| | Testing | Testing | Testing | Testing | Testing |
|---|---|---|---|---|---|
| | Example 1 | Example 2 | Example 3 | Example 4 | Example 5 |
| Rubber latex | Example 1 | Example 2 | Comp. | Comp. | Comp. |
| | | | Example 1 | Example 2 | Example 3 |
| Notch Izod | 34 | 32 | 30 | 27 | 31 |
| impact | | | | | |
| strength | | | | | |
| (23° C. | | | | | |
| Kg · cm/cm) | | | | | |
| Surface gloss | 96 | 98 | 88 | 92 | 93 |
| Amount of | 0.13 | 0.13 | 0.23 | 0.16 | 0.15 |
| coloring | | | | | |
| agent used | | | | | |
| (parts by | | | | | |
| weight) | | | | | |
| Coloring | 30.2 | 30.3 | 30.6 | 30.2 | 30.6 |
| property, L | | | | | |
| Coloring | 53.3 | 53 | 53 | 53.2 | 52.9 |
| property, a | | | | | |

* Amount of coloring agent used is the per 100 parts by weight of dry ABS powder and SAN.

In accordance with the method for preparing rubber latex of the present invention, it is possible to prepare core-shell type rubber latex capable of maximizing surface grafting ratio of rubber latex without sacrificing uniformity of polymerization system and particle stabilization and prepare resin having superior impact resistance, coloring property and gloss, when applied to ABS resins.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A method for preparing rubber latex, wherein hard polymer seed is fed into a polymerization reactor equipped with a condenser before commencing polymerization and the condenser is operated from the start of the polymerization, so that the condensate containing the aliphatic conjugated diene compound which forms the shell of the rubber latex is fed into the polymerization reactor.

2. The method for preparing rubber latex according to claim 1, wherein the hard polymer seed is polymerized from at least one monomer selected from the group consisting of an aromatic vinyl compound, an acrylic acid ester, a methacrylic acid ester and a vinyl cyanide compound and mixtures thereof.

3. The method for preparing rubber latex according to claim 1, wherein the hard polymer seed has an average particle diameter of at most 2,000 Å.

4. The method for preparing rubber latex according to claim 1, wherein the hard polymer seed is used in 10 to 20 parts by weight per 100 parts by weight of the aliphatic conjugated diene compound and the hard polymer seed.

5. The method for preparing rubber latex according to claim 1, wherein the shell of the rubber latex is prepared from an aliphatic conjugated diene compound alone or in combination with at least one monomer selected from the group consisting of an aromatic vinyl compound, acrylic acid ester, methacrylic acid ester and a vinyl cyanide compound.

6. The method for preparing rubber latex according to claim 5, wherein the aliphatic conjugated diene compound is at least one monomer selected from the group consisting of 1,3-butadiene, isoprene, chloroprene, pyperylene and mixtures thereof.

7. The method for preparing rubber latex according to claim 1, wherein the resultant rubber latex has an average particle diameter of 2,600 Å to 5,000 Å.
